(19) United States
(12) Patent Application Publication
(10) Pub. No.: US 2024/0149661 A1
(43) Pub. Date: May 9, 2024

(54) THERMAL MANAGEMENT FOR VEHICLES

(71) Applicant: Rivian IP Holdings, LLC, Plymouth, MI (US)

(72) Inventors: Graham Lloyd Feltham, Irvine, CA (US); Jake DeBoer, Mission Viejo, CA (US); Yashvardhan Salgaocar, Costa Mesa, CA (US); James Edward Bratby, Van Buren Twp, MI (US)

(21) Appl. No.: 18/148,921

(22) Filed: Dec. 30, 2022

Related U.S. Application Data
(60) Provisional application No. 63/424,110, filed on Nov. 9, 2022.

(51) Int. Cl. B60K 11/08

(52) U.S. Cl. CPC B60K 11/085

(57) ABSTRACT

Aspects of the disclosure relate to thermal management systems for a moveable apparatus such as a vehicle. A thermal management system may include an air intake at the front of the vehicle, and one or more structures that substantially reverse the airflow that flows into the air intake to impact a backside of a front wall of the vehicle. The front wall may be a front wall of a fascia of the vehicle in some implementations. The reversed airflow may flow over a heat exchanger before impacting the backside of the front wall, and may then be guided by an interior surface of the front wall to one or more vents or exit ports to the external environment.

### CROSS REFERENCE TO RELATED APPLICATIONS

This application claims the benefit of priority to U.S. Provisional Patent Application No. 63/424,110, entitled, “Thermal Management for Vehicles”, filed on Nov. 9, 2022, the disclosure of which is hereby incorporated herein in its entirety.

### INTRODUCTION

Vehicles often include air-to-liquid heat exchangers to cool their propulsion and energy sources, such as internal combustion engines powering wheels of the vehicle, a refrigerant compressor, or a battery/drive-unit on an electric vehicle. The conversion of chemical (fossil fuel) and/or electrical sources to mechanical energy (work and power) generates heat, which is rejected to the environment through the use of heat-exchangers.

Aspects of the subject technology can help to improve the overall efficiency and/or range of a vehicle, which can help to mitigate climate change by reducing greenhouse gas emissions.

### SUMMARY

The present description relates generally to thermal management, including, for example, thermal management for vehicles. One or more implementations of the disclosure relate to directing incoming air over a heat exchanger and into an otherwise unused air space behind or within a lower front fascia of a vehicle. As described in further detail hereinafter, aspects of the subject technology take incoming air and reverse the flow, turning the incoming air substantially around on itself. The reversed airflow can then be directed through an internal cavity within the lower front fascia to one or more vents or exit ports to the external environment. As described in further detail hereinafter, this airflow reversal has been found to synergize with the overall vehicle performance, such that underhood heating may be mitigated, the airflow rate may be the same or more than existing systems, the cooling drag may be the same or less than existing systems, and the package space for the thermal management system may be smaller, which may allow the size(s) of one or more other vehicle components and/or spaces to be increased.

In accordance with one or more aspects of the disclosure, a thermal management system for an apparatus is provided. The thermal management system may be configured to direct air onto an interior surface, or a backside, of a front wall of a body of the apparatus. The thermal management system may include a condenser radiator fan module (CRFM), such as a reverse-flow CRFM. The front wall of the body of the apparatus may include a front wall of a front fascia of a vehicle. The thermal management system may include at least one element configured to direct the air onto the interior surface of the front wall of the body by modifying (e.g., redirecting) an airflow pathway of at least a portion of the air to a backside of the front fascia.

In accordance with one or more aspects of the disclosure, a fascia for a vehicle is provided, the fascia including an internal cavity and an opening configured to receive airflow into the internal cavity from a fan of a condenser radiator fan module. The fascia may include a front fascia for the vehicle, and the internal cavity may be configured to extend from the opening to an additional opening at a wheel well of the vehicle.

In accordance with one or more aspects of the disclosure, an apparatus is provided that includes a body; an air intake at a front end of the body, the air intake configured to receive airflow in a first direction; and at least one element configured to redirect at least a portion of the airflow in a second direction substantially opposite the first direction to a backside of the front end of the body. The at least one element may include a structural element configured to modify at least the portion of the airflow when the apparatus is in motion. The structural element may include a wall of a front cargo compartment. The at least one element may include a fan configured to move air when the apparatus is stationary. In one or more implementations, the modified at least the portion of the airflow flows over a heat exchanger into a cavity within the front end.

In one or more implementations, an external surface of a wall of the front end is configured to be impacted by another portion of the airflow when the apparatus is in motion, and the backside of the front end includes an internal surface of the wall of the front end that is configured to be impacted by at least the portion of the airflow while the other portion of the airflow impacts the external surface. In one or more implementations, at least the portion of the airflow that impacts the internal surface of the wall of the front end mitigates a drag effect, on the apparatus, of the modification of the airflow. The cavity of the front end may extend from a first portion disposed at a front end of the body of the apparatus to a wall of a wheel well of the body of the apparatus.

In one or more implementations, the apparatus may include a vent in the wall of the wheel well. The cavity of the front end may be configured to route the airflow to, and through, the vent in the wheel well of the body of the apparatus. In one or more implementations, the apparatus may also include at least one opening in a bottom wall of the front end that allows the airflow to flow from the cavity within the front end through the at least one opening to an external environment of the apparatus. The apparatus may also include at least one flap for the at least one opening in the bottom wall of the front end.

In various implementations, the front end may include a bottom fascia disposed below the air intake or a top fascia disposed above the air intake. In one or more implementations, the apparatus is a vehicle, the first direction is substantially opposite to a forward drive direction of the vehicle, and the second direction is substantially parallel with the forward drive direction of the vehicle.

In accordance with one or more aspects of the disclosure, an apparatus is provided that includes an air intake configured to receive an airflow in a first direction; a front end having an internal cavity fluidly coupled to the air intake, and at least one element configured to redirect at least a portion of the airflow to a second direction substantially opposite the first direction; and a wheel well having a vent fluidly coupled to the internal cavity. The apparatus may also include a thermal management system including the at least one element, the thermal management system configured to direct airflow from the air intake, through at least a portion of the internal cavity of the front end, and through the vent into the wheel well. For example, the apparatus may include a vehicle, and the vehicle may also include a skid plate at or near a bottom of the front end; a plurality of openings in the skid plate; and a plurality of flaps for the plurality of openings, the plurality of flaps having an open position that allows air to flow through the plurality of openings, and a closed position that prevents the air from flowing through the plurality of openings.

In accordance with one or more aspects of the disclosure, a method is provided that includes receiving, by a thermal management system of a vehicle, airflow in a direction substantially opposite to a forward drive direction of the vehicle; and reversing the airflow to a direction substantially parallel to the forward drive direction of the vehicle. The method may also include directing the airflow in the direction substantially parallel to the forward drive direction of the vehicle over a heat exchanger. Reversing the airflow may include reversing the airflow while the vehicle is in motion in the forward drive direction with a portion of a wall of a cargo space within a body of the vehicle. Reversing the airflow may also, or alternatively, include reversing the airflow while the vehicle is stationary with a fan that moves the airflow over a heat exchanger in the direction substantially opposite the forward drive direction of the vehicle.

In accordance with one or more aspects of the disclosure, a structural component for a movable apparatus is provided, the structural component including: an outer wall having an interior surface and an external surface; and an internal cavity defined at least in part by the interior surface. The external surface may be configured to receive a first portion of an airflow in a first direction as a result of motion of the movable apparatus, and the interior surface may be configured to: receive a second portion of the airflow in a second direction substantially opposite the first direction as a result of the motion of the movable apparatus, and redirect at least some of the second portion of the airflow through the internal cavity to an exit port of the structural component.

In accordance with one or more aspects of the disclosure, a structural component for a movable apparatus is provided, the structural component including an outer wall having an interior surface; and an external surface of the outer wall, the external surface configured to receive a first portion of an airflow in a first direction as a result of motion of the movable apparatus. The interior surface may be configured to receive a second portion of the airflow in a second direction substantially opposite the first direction.

In one or more implementations, the apparatus may include a vehicle and the structural component may include a fascia of the vehicle. In one or more implementations, the structural component may also an internal cavity defined at least in part by the interior surface, and the interior surface may be configured to redirect at least some of the second portion of the airflow through the internal cavity to an exit port of the structural component. The exit port may be configured to fluidly couple to a vent in a wheel well of the vehicle, and the fascia may form a part of a thermal management system for the vehicle. The second portion of the airflow in the second direction that is received by the interior surface may be configured to mitigate a drag effect of the airflow on the moveable apparatus.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle in accordance with one or more implementations.

FIG. 2 illustrates a schematic front perspective view of an example implementation of a vehicle in accordance with one or more implementations.

FIG. 3 illustrates a cross-sectional side view of a portion of a thermal management system of a vehicle, in accordance with implementations of the subject technology.

FIG. 4 illustrates a cross-sectional perspective view of the portion of the thermal management system of the vehicle of FIG. 3, in accordance with implementations of the subject technology.

FIG. 5 illustrates a cross-sectional top view of a portion of a thermal management system of a vehicle, in accordance with implementations of the subject technology.

FIG. 6A illustrates a rear perspective view of a structural component having vents that may be disposed in a wall of a wheel well of a vehicle, in accordance with implementations of the subject technology.

FIG. 6B illustrates a perspective view of a vent disposed in a wall of a wheel well of a vehicle, in accordance with implementations of the subject technology.

FIG. 6C illustrates a front perspective view the structural component of FIG. 6A, in accordance with implementations of the subject technology.

FIG. 7 illustrates a cross-sectional perspective view of a dynamic vent in a fascia of a vehicle, in accordance with implementations of the subject technology.

FIG. 8 illustrates a bottom perspective view of a dynamic vent in a fascia of a vehicle, in accordance with implementations of the subject technology.

FIG. 9 illustrates a cross-sectional perspective view of the dynamic vent of FIG. 7 in a closed configuration, in accordance with implementations of the subject technology.

FIG. 10 illustrates a flow chart of example operations that may be performed by a thermal management system of a vehicle in accordance with implementations of the subject technology.

FIG. 11 illustrates a flow chart of example operations that may be performed using a structural component of a moveable apparatus in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In many vehicles, heat exchangers are located at the front of the vehicle, behind a semi-open grille. This heat exchanger arrangement is typically to provide a balance between adequate cooling airflow, underhood packaging space, underhood heating (e.g., due to heat being rejected into air that passes into the vehicle's underhood before exiting out into the environment), system complexity, and impact to overall vehicle aerodynamic drag.

Many “front end packs”, or condenser, radiator, fan-modules (CRFMs), have been implemented. Some are un-ducted, some are partially ducted, and some are fully ducted. The level of ducting implemented impacts the system airflow performance, the package space, the underhood heating, and the overall impact to vehicle drag. Ducting can be used to partially guide or fully guide inlet and/or exhaust airflow to benefit one or all of the above aspects.

Implementations of the subject technology described herein provide a tight package around formerly unused air space behind a front fascia of a vehicle (e.g., a lower front fascia). Aspects of the subject technology take incoming air, and turn it around, or reverse the flow of the incoming air, back toward the front of the vehicle.

As described herein, airflow reversal, which can be provided by a thermal management system such as a reverse-flow CRFM, has been shown to synergize with the overall vehicle performance, such that the underhood heating is mitigated, the airflow rate is the same or more than systems without airflow reversal, the cooling drag is the same or less than systems without airflow reversal, and the package space is smaller than systems without airflow reversal, so that other vehicle components, such as a volume of a front cargo space (also referred to herein as a front trunk of “frunk”) can be increased in size (e.g., in comparison with vehicles implementing thermal management systems without an airflow reversal).

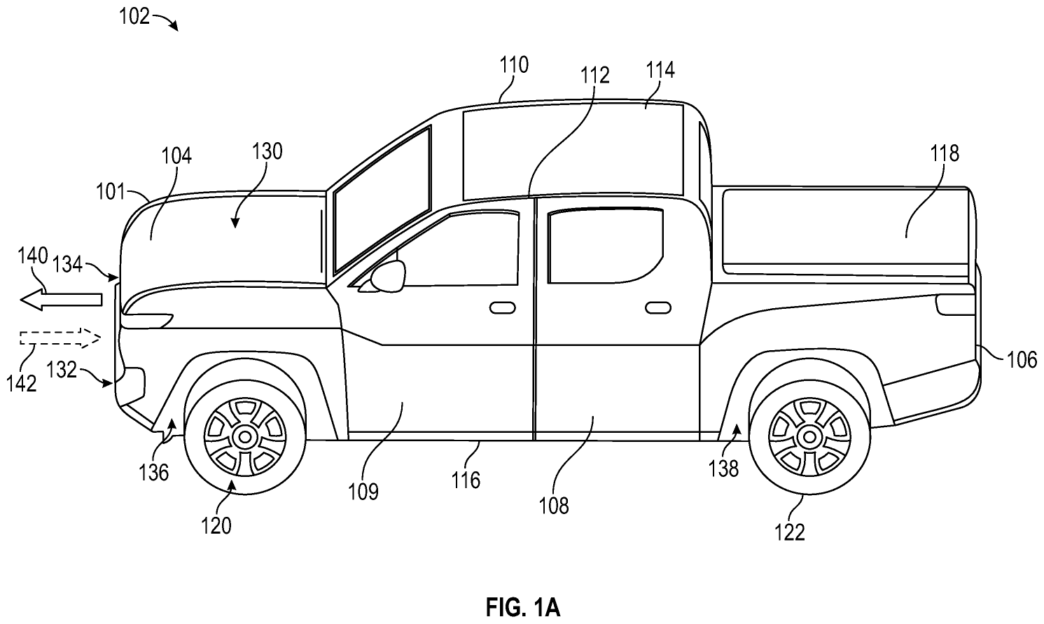

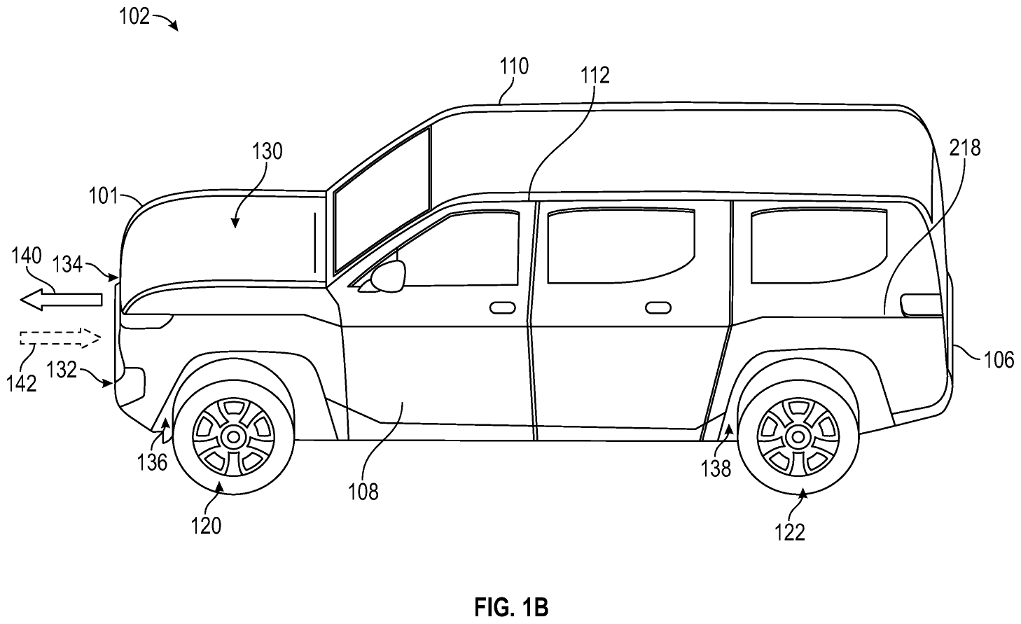

FIG. 1A is a diagram illustrating an example implementation of an apparatus as described herein. In the example of FIG. 1A, an apparatus is implemented as a moveable apparatus, such as a vehicle 102. In one or more implementations, the vehicle 102 may be an electric vehicle having one or more electric motors that drive the wheels of the vehicle. In one or more implementations, the vehicle 102 may also, or alternatively, include one or more chemically-powered engines, such as a gas-powered engine of a fuel cell powered motor.

As shown, the vehicle 102 may have a front portion 104 and a rear portion 106. A cabin 108 may be located between the front portion 104 and the rear portion 106 of the vehicle 102. The cabin 108 may include entry doors 109. There may be one, two, three, four, or five or more entry doors 109 to the cabin 108, which may contain one or more rows of seating for human occupants. As illustrated, the vehicle 102 has a right side 110 and a left side 112. Left side 112 may be referred to as a driver side of the vehicle, and right side 110 may be referred to as a passenger side of the vehicle in one or more implementations. In cases where the vehicle is an autonomous vehicle that does not require or is not configured for a human driver, the left side of the vehicle may still be referred to as a driver side as a matter of convenience. One or more of the entry doors may be located on the left side 112 of the vehicle, and one or more entry doors may be located on the right side 110 of the vehicle.

Vehicle 102 may include a roof 114, which may include racks or other equipment for storage (not shown). Vehicle 102 may have a chassis or unibody 116. Vehicle 102 may have one or more cargo spaces, such as a cargo bed or truck bed 118 (also referred to herein as a “trunk”) and/or a front cargo space 130 (also referred to herein as a front trunk or a “frunk”). Cargo bed 118 is typically located at or near the rear portion 106 of the vehicle. Vehicle 102 may have one or more front wheels 120 and one or more rear wheels 122. As shown, the front wheels 120 may each be partially disposed in a wheel well 136 of a body 101 of the vehicle 102. The rear wheels 122 may each be partially disposed in a wheel well 138 of the body 101. Vehicle 102 of FIG. 1A may be a unibody truck, which may have a storage bed. One or more portions of a body 101 of the vehicle 102 may be constructed of steel alloy and/or aluminum alloy or other suitable materials.

As shown in the example of FIG. 1A, the body 101 of the vehicle 102 may include one or more front fascia, such as front fascia 132 and/or front fascia 134. For example, the front fascia 132 may be a lower front fascia and the front fascia 134 may be an upper front fascia. As shown, the front fascia 132 and/or front fascia 134 are located at the front end of the vehicle 102. The front fascia 132 and/or front fascia 134 may provide an aesthetic front look for the vehicle 102 and may be arranged to provide external aerodynamic properties for the vehicle 102. In one or more implementations, the front fascia 132 and/or the front fascia 134 may be implemented as removable sections of the front end of the vehicle 102, and may be comprised of plastic or non-metal components (carbon fiber) that hide one or more structural elements (e.g., bodywork/frame) and give the vehicle a desired outer shape.

FIG. 1A also illustrates a forward drive direction 140 for the vehicle 102. For example, when the vehicle is in motion in the forward drive direction 140, the vehicle may move in a direction that extends along a path that extends from the rear portion 106 toward the front portion 104 of the vehicle. As shown, in one or more use cases, airflow may move, relative to the vehicle 102, in a direction 142 that is substantially opposite the forward drive direction 140 of the vehicle 102. For example, the airflow may move, relative to the vehicle, in the direction 142 due to motion of the vehicle 102 in the forward drive direction 140 through the surrounding air. As another example, the airflow may move, relative to the vehicle, in the direction 142 due to operation of a fan within the body 101 of the vehicle 102 that pulls the air in the direction 142.

FIG. 1B is a diagram illustrating another example implementation of the vehicle 102. Vehicle 102 in this example may have a rear portion 106 with a rear cargo space (trunk) 218, e.g., behind a row of occupant seating, that may be internal to the rear portion 106. Rear cargo space 218 may be referred to as a trunk or as a cargo bed or rear cargo space. FIGS. 1A and 1B, respectively, depict example implementations of the vehicle 102 as a truck and a sport utility vehicle. However, these example implementations are merely illustrative, and the vehicle 102 may be implemented as any type of vehicle or other moveable apparatus (e.g., including, but not limited to, a van, a delivery van, a semi-truck, an aircraft, a watercraft, or the like).

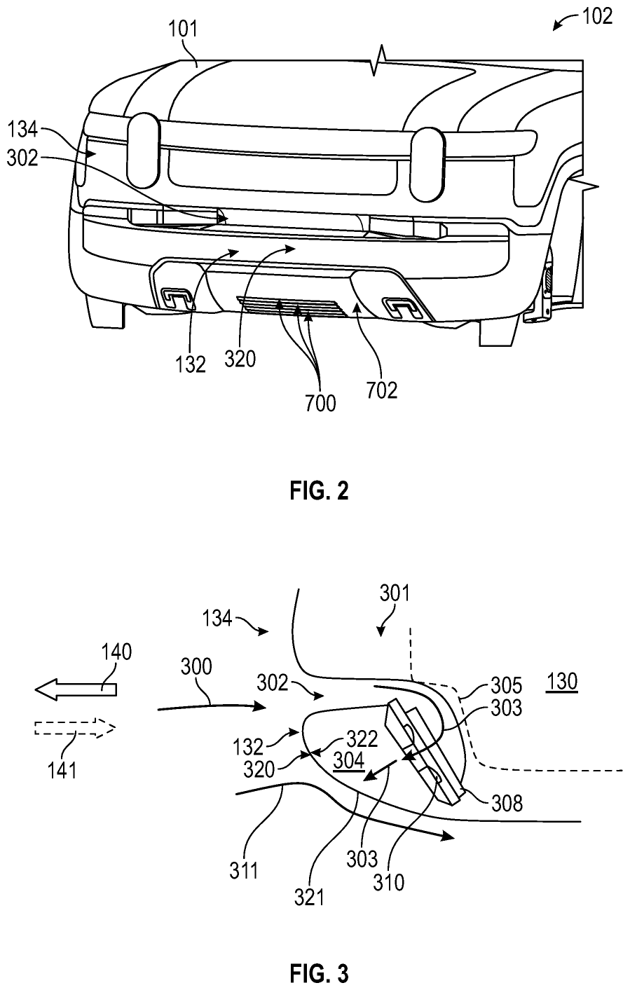

FIG. 2 illustrates a front perspective view of the front portion 104 of the vehicle 102 in accordance with one or more implementations. As shown in FIG. 2, the vehicle 102 may include the body 101 with the front fascia 132 and front fascia 134, and may include an air intake 302 (e.g., an opening and/or a duct) at a front end of the body 101. As shown, the air intake 302 may be disposed between the front fascia 132 and front fascia 134. In this example, air intake 302 is a single high-mounted intake, that is vertically slim relative to its horizontal width. FIG. 2 also illustrates how the vehicle 102 may include one or more openings 700 in a bottom wall 702 of the front end of the vehicle. For example, the bottom wall 702 may be a bottom wall of the front fascia 132 or a bottom wall of a separate component (e.g., a skid plate) of the vehicle. An external surface 320 of a wall of the front end of the vehicle 102 is also visible in FIG. 2.

FIG. 3 illustrates a cross-sectional side view of a portion of a thermal management system 301 of the vehicle 102, in accordance with implementations of the subject technology. As in the example of FIG. 2, in the example of FIG. 3, a vehicle 102 having a body 101 with a front fascia 132 may include an air intake 302 (e.g., an opening and/or a duct) at a front end of the body 101. The air intake 302 may be configured to receive airflow 300 in the direction 142 substantially opposite to the forward drive direction 140 of the vehicle 102. In one or more implementations, the vehicle 102 (e.g., a thermal management system 301 of the vehicle 102) may include at least one element configured to modify at least a portion 303 of the airflow 300 to a backside of the front end of the body. For example, the backside of the front end may be an interior surface 322 of the wall 321 of the front end (e.g., a wall of the front fascia 132 or other front end structure). For example, the at least one element may be configured to reverse at least the portion 303 of the airflow 300 to a second direction substantially parallel with the forward drive direction 140 of the vehicle 102.

For example, the at least one element may include a structural element configured to reverse at least the portion 303 of the airflow 300 when the vehicle is in motion in the forward drive direction 140. For example, the structural element may include a wall 305 of a front cargo space 130. The wall 305 may have a shape that is configured to guide the portion 303 of the airflow back toward the front of the vehicle 102. As another example, the at least one element may include a fan 310 or other blower configured to move air in the second direction when the vehicle is stationary and/or moving in the forward drive direction 140 (or another direction) at relatively low speeds (e.g., less than five miles per hour, less than ten miles per hour, or less than fifteen miles per hour). As illustrated in FIG. 3, the portion 303 of the airflow 300 that is reversed may move in a direction that has at least a vector component that is parallel to the forward drive direction 140, and a (smaller) vector component that is normal to the forward drive direction 140 in some use cases.

As shown, the portion 303 of the airflow 300 in the second direction may flow over (e.g., through) one or more heat exchangers 308 into a cavity 304 (e.g., an internal cavity) within the front fascia 132. For example, the heat exchangers 308 and the fan 310 may be parts of a condenser, radiator, fan-module (CRFM) for the vehicle 102. For example, the heat exchanger 308 and/or the fan 310 may be disposed in an interior opening, such as opening 351, in the front fascia 132. In the example of FIG. 3, the fan 310 is mounted downstream of the heat exchanger(s) 308, and is configured to pull the air through the heat exchanger(s) 308 in the second direction. However, this is merely illustrative and a fan/blower may be mounted anywhere in the airflow path, and arranged to pull or push air through the heat exchanger(s) 308. In one or more other examples, the fan 310 can be mounted upstream of the heat exchanger(s) 308 to push the air through the heat exchanger(s) 308, or can be mounted away from the heat exchanger(s) 308, such as at or near the wheel wells 136.

In contrast with a thermal management system that does not reverse the airflow from the external environment and that thus allows warmed air flowing over a heat exchanger to continue in the direction 142 and impact (and heat) internal structural elements of the vehicle (e.g., internal structural elements that may be at or near user accessible spaces of the vehicle, such as the occupant cabin or a frunk of the vehicle, which may be undesirably warmed by the warmed air), the reverse-flow CRFM system of FIG. 3 redirects warmed air away from user accessible spaces, such that resulting warmed zones of the vehicle are located away from user accessible spaces.

Redirecting warm air away from user accessible spaces in this way can be helpful, for example, to avoid warming a cargo space, such as the front cargo space 130 that may be used to temporarily store perishable goods, such as groceries and the like. Indeed, aspects of the subject technology may act to cool the front cargo space 130 with the portion 303 of the airflow 300 that is reversed by the wall 305 of the front cargo space 130. As another example, aspects of the subject disclosure may act to avoid warming, or even to cool, a passenger compartment of a moveable apparatus (such as the vehicle 102) using the portion 303 that is reversed before that portion of the airflow passes over the heat exchanger 308. This can improve the efficiency and/or reduce the usage of cabin temperature control systems (e.g., including refrigerant-based air conditioning systems) for the passenger compartment, which can positively impact the climate by reducing greenhouse gas emissions.

In one or more implementations, an external surface 320 of a wall 321 of the front end (e.g., a wall of the front fascia 132) is configured to be impacted by another portion 311 of the airflow 300 (e.g., in the direction 142) when a moveable apparatus (such as the vehicle 102) including the wall 321 is in motion (e.g., in the forward drive direction 140). An interior surface 322 (e.g., a backside) of the wall 321 of the front end (e.g., the front fascia 132) may be configured to be impacted by at least the portion 303 of the airflow (e.g., in the direction substantially parallel to the forward drive direction 140) while the other portion 311 of the airflow 300 impacts the external surface 320 (e.g., in the direction 142).

For example, at least the portion 303 of the airflow 300 that impacts the interior surface 322 (e.g., also referred to herein as an internal surface) of the wall 321 of the front fascia 132 may mitigate a drag effect, on the vehicle 102, of the reversal of the airflow 300 (e.g., as caused by the portion 303 impacting the wall 305). For example, portion 303 of the airflow 300 that impacts the interior surface 322 may pressurize the interior surface 322 in a way that at least partially counters a pressure on the external surface 320 by the portion 311 of the airflow 300 and/or a pressure on the wall 305 by the portion 303 of the airflow 300 that is reversed by the wall 305. For example, this pressurizing of the interior surface 322 may provide a forward force on the vehicle that at least partially counters a drag force on the wall 305 and/or a drag force on the external surface 320.

In one or more implementations, portions of the wall 321 that are impacted on the internal surface by the portions 303 of the airflow 300 may experience a drag (e.g., when a movable apparatus including the wall 321 such as the vehicle 102 is in motion in the forward drive direction 140) that is reduced by a factor of 1.5, a factor of two, or as much as or more than a factor of five in comparison with a wall 321 having no airflow impacting the interior surface 322 of the wall 321. Reducing vehicle drag in this way can improve the overall efficiency and/or range of the vehicle which (e.g., in combination with implementing the vehicle as an electric vehicle that emits little to no greenhouse gasses during operation) can positively impact the climate by reducing greenhouse gas emissions.

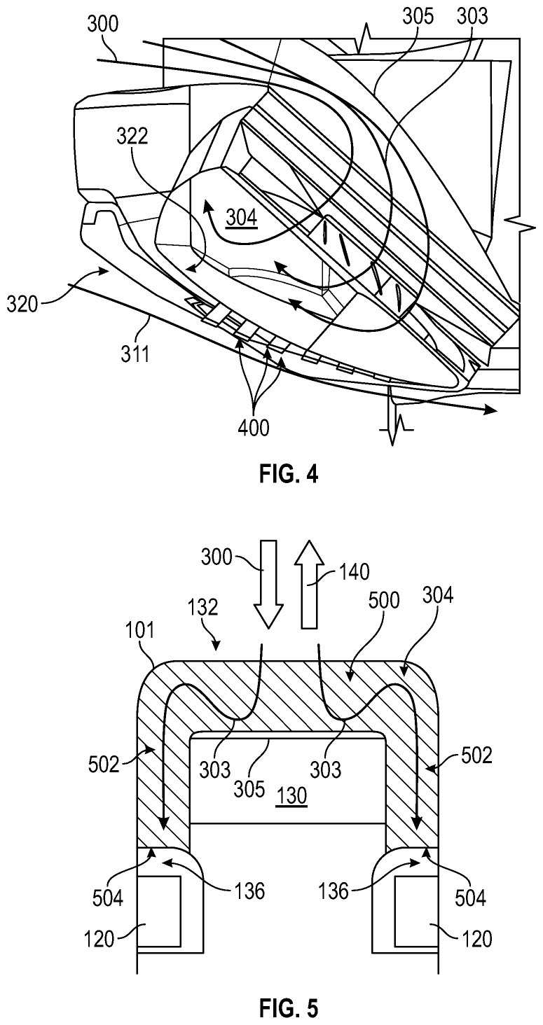

FIG. 4 illustrates a cross-sectional perspective view of the portion of the thermal management system of the vehicle of FIG. 3, in accordance with implementations of the subject technology. In the example of FIG. 4, multiple speed flaps 400 can be seen covering multiple corresponding openings (e.g., openings 700 of FIG. 2) in a bottom wall (e.g., bottom wall 702 of FIG. 2) of the front fascia 132. For example, the openings and the speed flaps 400 may be provided in a skid plate portion of the front fascia. The speed flaps 400 may be located forward of the wheel wells 136 of the vehicle 102.

In the example of FIG. 4, the speed flaps are closed due to pressure thereon from the portion 311 of the airflow 300. In one or more implementations, the speed flaps 400 may be configured to rest in an open position when the vehicle is stationary or moving at a slow speed (e.g., less than fifteen miles per hour, less than ten miles per hour, or less than five miles per hour) and to be pushed closed by the portion 311 of the airflow 300 when the vehicle speed increases (e.g., to above fifteen miles per hour, above than ten miles per hour, or above than five miles per hour). In one or more other implementations, the speed flaps 400 may be configured to rest in the closed position of FIG. 4 whether the vehicle is in motion or stationary, and to be pushed open by the airflow 300 when the vehicle is stationary and the fan 310 pushes or pulls the portion 303 of the airflow 300 over the heat exchanger 308 into the cavity 304. In these implementations, when the vehicle is in motion in the forward drive direction 140, a pressure on the speed flaps 400 by the portion 311 of the airflow 300 may overcome an opposing pressure on the speed flaps 400 by the portion 303 of the airflow 300 to keep the speed flaps 400 in the closed position of FIG. 3.

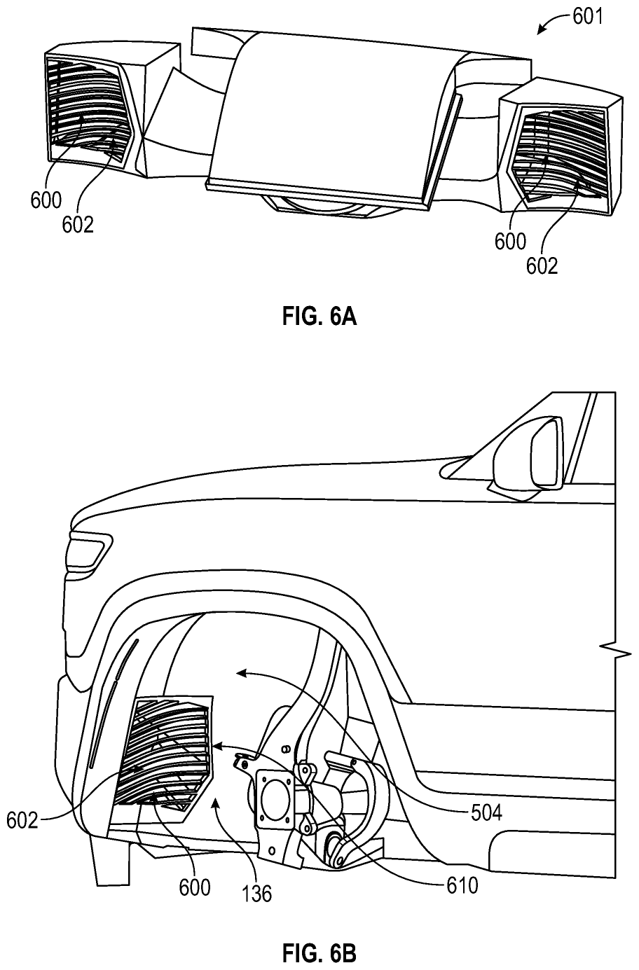

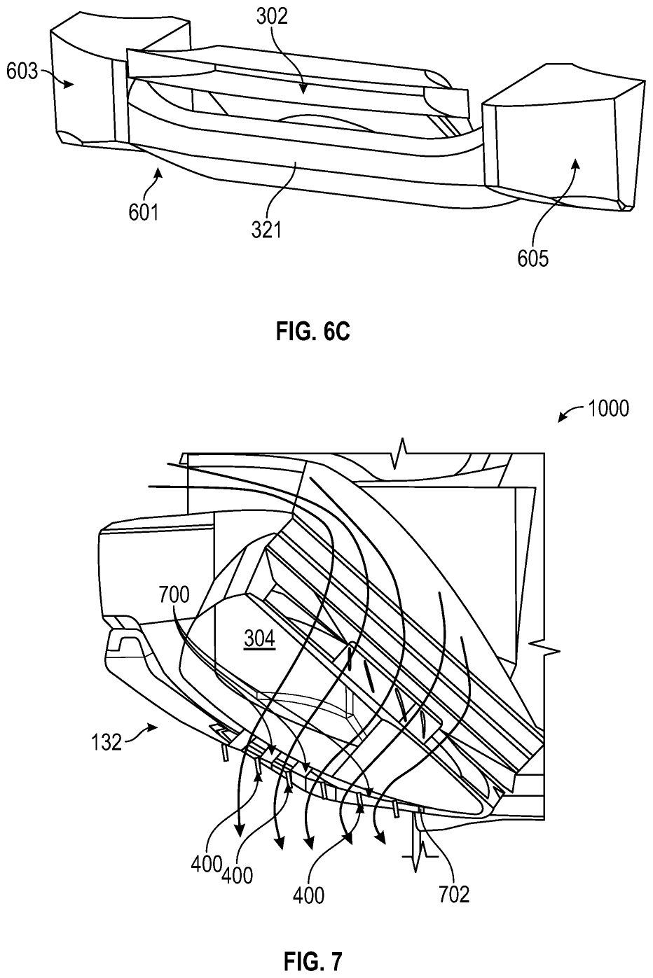

FIG. 5 illustrates a cross-sectional top view of a portion of a thermal management system of a vehicle, in accordance with implementations of the subject technology. As illustrated in FIG. 5, the cavity 304 of the front fascia 132 may extend from a first portion 500 disposed at the front of the body 101 of the vehicle to a wall 504 of the wheel well 136 of the body 101 of the vehicle 102. As shown in FIG. 6A, a structural component 601 (e.g., the front fascia 132) that may be implemented in a moveable apparatus such as the vehicle 102 may also include one or more exit ports such as vents 600 that are configured to be disposed in the walls 504 of the wheel wells 136. For example, FIG. 6B illustrates a perspective view of a portion of the vehicle 102 including a wheel well 136 (e.g., a front wheel well), and showing how the vent 600 of the structural component 601 may be disposed in and fluidly coupled to wheel well 136. In this way, the cavity 304 in the structural component 601 (e.g., the front fascia 132) may be fluidly coupled, via the vent 600, to the wheel well 136.

For example, the vent 600 in each of the wheel wells 136 may be formed as a part of the front fascia 132, and the front fascia 132 may be mounted to the vehicle 102 such that the vents 600 are mounted to respective openings 610 in the wall 504 of the wheel well 136 of the body 101 of the vehicle 102. As shown in FIG. 6A, the vehicle 102 may also include one or more louvers 602 across the vent 600. In various implementations, the louvers 602 may be mounted to the opening 610 in the wall 504 (e.g., such that an exit port formed by vent 600 of the structural component 601 is mounted in alignment with the opening 610), or the louvers 602 may be mounted to the vents 600 of the structural component 601 and mounted in the openings 610 when the exit ports of the structural component 601 are mounted in alignment with the opening 610.

FIGS. 5 and 6A and 6B illustrate how the cavity 304 of the front fascia 132 may be configured to (e.g., after the portion 303 of the airflow 300 has been reversed by the wall 305 of the front cargo space 130 and resultingly impacted the backside, or interior surface 322, of the front fascia 132) route the portion 303 of the airflow 300 from the direction substantially parallel to the forward drive direction 140 to, and through, the vent 600 (e.g., via another portion 502 of the cavity 304) into the wheel well 136 of the body 101 of the vehicle 102. When the vehicle 102 is in motion, the wheel wells 136 may have an air pressure that is less than the air pressure within the cavity 304, due to the external airflow and a pumping action of the rotating front wheels 120 (see, e.g., FIGS. 1 and 2) in the wheel wells 136. Thus, the relative negative pressure in the wheel wells 136 may aid in directing the portion 303 of the airflow 300 toward and then around the corners of the vehicle within the cavity 304, through the portion 502 of the cavity, and to and through the vent 600 into the wheel wells 136.

FIG. 6C illustrates a front perspective view of the structural component 601 of FIG. 6A (e.g., the front fascia 132) showing an illustrative location of the air intake 302 relative to the structural component 601. For example, the structural component 601 may be implemented as the front fascia 132, and the air intake 302 may be disposed above the wall 321 of the front fascia and substantially between two portions 603 and 605 of the front fascia 132 at the ends of the front fascia 132. For example, the portions 603 and 605 of the front fascia 132 may be disposed at or near the front corners of the vehicle 102 in one or more implementations. In various implementations, the air intake 302 may be formed from a separate duct that feeds the portion 303 of the airflow 300 to the wall 305 of the front cargo space 130, or may be formed by parts of other structures (e.g., by a part of the front fascia 132 and a part of the wall 305).

As illustrated in FIGS. 5 and 6A-6C, the portion 303 of the airflow 300 may enter the air intake 302 in a direction 142 (relative to a movable apparatus, such as the vehicle 102, implementing the structural component 601), may then be reversed by the wall 305 of the front cargo space 130 into substantially an opposite direction to the direction 142 (e.g., a direction parallel to the forward drive direction 140 of the vehicle 102), may then impact the interior surface 322 of the structural component 601 (e.g., the front fascia 132) and be redirected by the interior surface 322 toward the edges of the structural component 601 (e.g., toward the corners of the vehicle 102), and may then be redirected by the structural component 601 (e.g., by the interior surface 322) to bend again into a direction parallel with the direction 142 in which the portion 303 of the airflow 300 entered the air intake 302, and may then exit the cavity 304 via the vents 600 and the corresponding openings 610 in the wheel wells 136 (e.g., aided, in some implementations, by a negative pressure differential between the wheel wells 136 and the cavity 304).

As illustrated in FIGS. 3-6C, a structural component 601 (e.g., the front fascia 132 or the front fascia 134) may be provided for a movable apparatus (e.g., the vehicle 102). In one or more implementations, the structural component 601 may include an outer wall (e.g., wall 321) having an interior surface 322 and an external surface 320. The structural component 601 may also include an internal cavity (e.g., cavity 304) defined at least in part by the interior surface 322. The external surface 320 may be configured to receive a first portion (e.g., portion 311) of an airflow (e.g., airflow 300) in a first direction (e.g., direction 142) as a result of motion of the movable apparatus (e.g., in the forward drive direction 140). In one or more implementations, the interior surface 322 may be configured to receive a second portion (e.g., the portion 303) of the airflow in a second direction substantially opposite the first direction as a result of the motion of the movable apparatus. The interior surface 322 may also redirect at least some of the second portion of the airflow through the internal cavity (e.g., cavity 304) to an exit port (e.g., a vent 600 or one or more openings 700) of the structural component 601 (e.g., as illustrated in FIG. 5).

In one or more implementations, the apparatus may include a vehicle and the structural component may include a fascia of the vehicle. In one or more implementations, the exit port (e.g., a vent 600) is configured to fluidly couple to an opening in a wheel well (e.g., a wheel well 136) of the vehicle, and the fascia forms a part of a thermal management system for the vehicle. The thermal management system may include, in one or more implementations, the structural component 601, one or more fans such as the fan 310, and/or one or more heat exchangers such as the heat exchanger(s) 308. In one or more implementations, the thermal management system may include the openings 700 and/or the speed flaps 400 (or other closing mechanism(s) for the openings 700). In one or more implementations, the thermal management system may include the louvers 602 or similar structures for the vent(s) 600. In one or more implementations, the second portion of the airflow in the second direction that is received by the interior surface 322 is configured to mitigate a drag effect of the airflow 300 on the moveable apparatus, as discussed herein.

FIG. 7 illustrates a cross-sectional perspective view of a (e.g., passive) dynamic vent in a structural component of an apparatus, such as a fascia of a vehicle, in accordance with implementations of the subject technology. As shown in FIG. 7, the vehicle 102 may include one or more openings 700 in a bottom wall 702 of the front fascia 132. The openings 700 may allow airflow (e.g., at least the portion 303 of the airflow 300) to flow from the cavity 304 within the front fascia 132 through openings 700 to an external environment of the vehicle. For example, the fan 310 of FIG. 3 may move (e.g., pull or push) the portion 303 of the airflow 300 over the heat exchanger(s) 308, and move (e.g., push or pull) the heated air out of the openings 700 (e.g., when the vehicle is stationary or moving at relatively low speeds). In this way, an outlet for the fan flow can be provided, which can improve the efficiency and function of the fan 310.

As shown in FIG. 7, the vehicle may also include one or more openable coverings, such as speed flaps 400, for the one or more openings 700 in the bottom wall 702 of the front fascia 132. In the example of FIG. 7, the speed flaps 400 are open, allowing air to flow through the openings 700. When the vehicle is moving in the forward drive direction 140, the portion 311 of the airflow 300 may push the speed flaps 400 closed to enhance the aerodynamic profile of the vehicle 102, causing the portion 303 of the airflow 300 to flow to the vents 600 in the wheel wells 136 (rather than through the openings 700), as illustrated by FIGS. 4 and 5.

In the examples described herein in connection with FIGS. 3-7, the portion 303 of the airflow 300 is modified (e.g., reversed) into the cavity 304 in the lower front fascia (e.g., front fascia 132) that is disposed below the air intake 302. However, in other implementations, the portion 303 of the airflow 300 and/or another portion of the airflow 300 may be modified (e.g., reversed) into a cavity in the upper front fascia (e.g., front fascia 134) of the vehicle 102 or another front end structure of the body 101 of the vehicle.

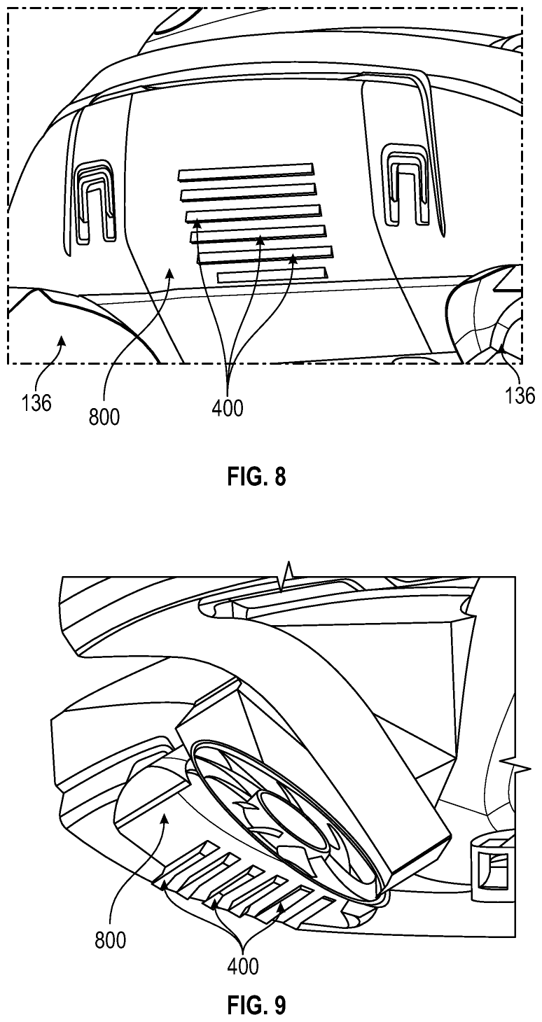

FIG. 8 illustrates a bottom perspective view of the dynamic vent of FIG. 7, in accordance with implementations of the subject technology. FIG. 9 illustrates a bottom perspective side view of the dynamic vent of FIG. 7, in accordance with implementations of the subject technology. As illustrated in FIGS. 8 and 9, the speed flaps 400 may be disposed in a skid plate 800 of the vehicle, located forward of the front wheel wells (e.g., wheel wells 136) of the vehicle. For example, the skid plate 800 may be a portion of the front fascia 132 or may be another structure mounted to or near the front fascia 132, and may be formed from an abrasion-resistant material.

In the examples of FIGS. 3-9, an apparatus such as the vehicle 102 includes an air intake 302, a front end (e.g., front fascia 132) having an internal cavity (e.g., cavity 304) fluidly coupled to the air intake 302, and a wheel well 136 having a vent 600 fluidly coupled to the internal cavity. In these examples, the vehicle 102 also includes a thermal management system 301 configured to direct airflow from the air intake 302, through at least a portion of the internal cavity of the front end (e.g., the front fascia 132), and through the vent 600 into the wheel well 136. In these examples, the vehicle includes a skid plate 800 at or near a bottom of the front fascia 132 (e.g., on or as part of the bottom wall 702 of FIG. 3), openings 700 in the skid plate 800, and flaps (e.g., speed flaps 400) for the openings 700. The flaps (e.g., speed flaps 400) have an open position (see, e.g., FIG. 7) that allows air to flow through the openings 700, and a closed position (see, e.g., FIG. 4) that prevents the air from flowing through the openings 700. For example, the speed flaps 400 may naturally close when the vehicle 102 is at speed, which may also reduce drag on the vehicle 102. In this way, a passive venting system may be provided for the vehicle 102 in one or more implementations.

In the examples of FIGS. 3-9, a thermal management system 301 for an apparatus (e.g., vehicle 102) may be configured to direct air onto an interior surface (e.g., interior surface 322) of a front wall (e.g., wall 321) of a body (e.g., body 101) of the apparatus. The thermal management system 301 may include a condenser radiator fan module (CRFM). The front wall of the body of the apparatus may include a front wall of a front fascia (e.g., front fascia 132) of a vehicle (e.g., vehicle 102). The thermal management system 301 may include at least one element (e.g., wall 305 or fan 310) configured to modify at least a portion (e.g., portion 303) of the airflow to a backside (e.g., interior surface 322) of the front fascia.

In the examples of FIGS. 3-9, a fascia (e.g., front fascia 132 or front fascia 134) for a vehicle (e.g., vehicle 102) may include an internal cavity (e.g., cavity 304) and an opening 351 configured to receive airflow into the internal cavity from a fan of a condenser radiator fan module. For example, the fascia may be a front fascia for the vehicle, and the internal cavity may be configured to extend from the opening 351 to an additional opening (e.g., vent 600) at a wheel well (e.g., wheel well 136) of the vehicle. For example, the heat exchanger 308 and/or the fan 310 may be disposed in the opening 351.

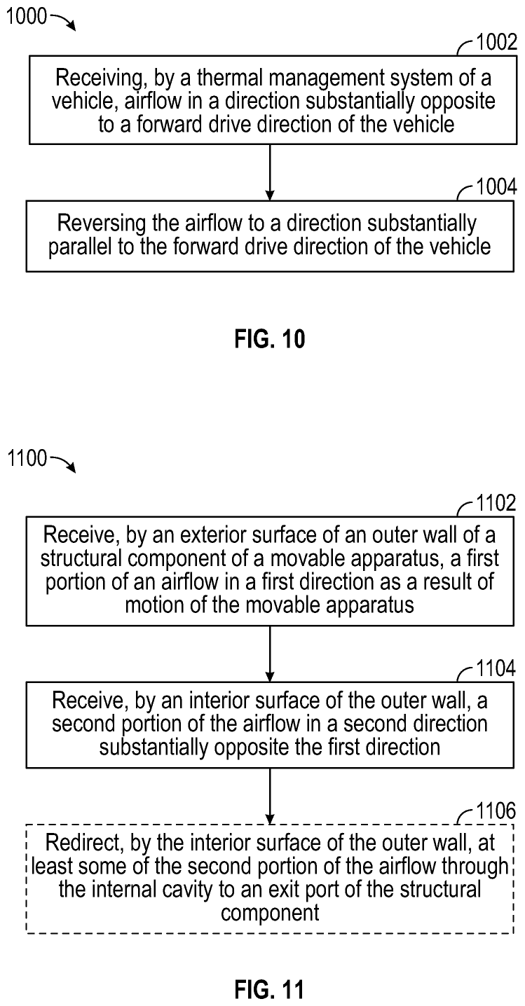

FIG. 10 illustrates a flow diagram of an example process 1000 that may be performed by a thermal management system of a vehicle, in accordance with implementations of the subject technology. For explanatory purposes, the process 1000 is primarily described herein with reference to the vehicle 102 of FIGS. 1 and 2. However, the process 1000 is not limited to the vehicle 102 of FIGS. 1 and 2, and one or more blocks (or operations) of the process 1000 may be performed by one or more other components of other suitable apparatuses, devices, or systems. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, a thermal management system (e.g., thermal management system 301) of a vehicle (e.g., vehicle 102) may receive airflow (e.g., airflow 300) in a direction (e.g., direction 142) substantially opposite to a forward drive direction (e.g., forward drive direction 140) of the vehicle.

At block 1004, the thermal management system may reverse the airflow to a direction substantially parallel to the forward drive direction of the vehicle. For example, the thermal management system may direct the airflow in the direction substantially parallel to the forward drive direction of the vehicle over a heat exchanger (e.g., a heat exchanger such as heat exchanger 308 of FIG. 3). In one or more use cases, reversing the airflow may include reversing the airflow while the vehicle is in motion in the forward drive direction with a portion of a wall (e.g., wall 305) of a cargo space (e.g., front cargo space 130) within a body (e.g., body 101) of the vehicle. In one or more other use cases, reversing the airflow may include reversing the airflow while the vehicle is stationary with a fan (e.g., fan 310) that pulls the airflow over the heat exchanger in the direction substantially opposite the forward drive direction of the vehicle.

FIG. 11 illustrates a flow diagram of an example process 1100 that may be performed using a structural component of a movable apparatus, in accordance with implementations of the subject technology. For explanatory purposes, the process 1100 is primarily described herein with reference to the vehicle 102 of FIGS. 1 and 2. However, the process 1100 is not limited to the vehicle 102 of FIGS. 1 and 2, and one or more blocks (or operations) of the process 1100 may be performed by one or more other structural components of other suitable moveable apparatuses, devices, or systems. Further for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

As illustrated in FIG. 11, at block 1102, a structural component (e.g., structural component 601 such as the front fascia 132) of a moveable apparatus (e.g., the vehicle 102) may receive, by an exterior surface (e.g., external surface 320) of an outer wall (e.g., wall 321) of the structural component of the movable apparatus, a first portion (e.g., portion 311) of an airflow (e.g., a portion 311 of airflow 300) in a first direction (e.g., direction 142) as a result of motion (e.g., in the forward drive direction 140) of the movable apparatus. In one or more implementations, the exterior surface of the outer wall of the structural component may also, or alternatively, receive an airflow (e.g., a portion 311 of airflow 300) as a result of operation of a fan 310 disposed within or adjacent to the structural component.

At block 1104, an interior surface (e.g., the interior surface 322, which is also referred to herein as a backside or an internal surface) of the outer wall, may receive a second portion (e.g., portion 303) of the airflow in a second direction substantially opposite the first direction (e.g., as a result of the motion of the movable apparatus). For example, as described herein, the portion 303 of the airflow may be reversed to impact the interior surface. For example, the portion 303 of the airflow may impact a wall 305 within the vehicle, which may substantially reverse the direction of the portion 303 of the airflow. In one or more implementations, reversing the direction of the portion 303 of the airflow may direct the portion 303 of the airflow over a heat exchanger 308 and into contact with the interior surface.

As shown in FIG. 11, the process 1100 may optionally include a block 1106. At block 1106, the interior surface of the outer wall may redirect at least some of the second portion of the airflow through the internal cavity to an exit port (e.g., a vent 600 or one or more openings 700) of the structural component (e.g., as described herein in connection with FIGS. 5, 6A, 6B, and 6C). In one or more implementations, the outer wall of the structural component may include one or more openings (e.g., openings 700) between the internal cavity and an external environment of the structural component. In one or more implementations, one or more flaps (e.g., speed flaps 400) may be provided that allow airflow through the openings when the vehicle is stationary or moving at a slow speed (e.g., less than five miles per hour or less than ten miles per hour), and that close due to an airflow resulting from motion (e.g., in the forward drive direction 140) of the movable apparatus when the moveable apparatus is moving at speed (e.g., faster than five miles per hour or faster than ten miles per hour).

In one or more implementations, the thermal management system may reverse the airflow to a direction substantially parallel to the forward drive direction of the vehicle. For example, the thermal management system may direct the airflow in the direction substantially parallel to the forward drive direction of the vehicle over a heat exchanger (e.g., a heat exchanger such as heat exchanger 308 of FIG. 3). In one or more use cases, reversing the airflow may include reversing the airflow while the vehicle is in motion in the forward drive direction with a portion of a wall (e.g., wall 305) of a cargo space (e.g., front cargo space 130) within a body (e.g., body 101) of the vehicle. In one or more other use cases, reversing the airflow may include reversing the airflow while the vehicle is stationary with a fan (e.g., fan 310) that pulls the airflow over the heat exchanger in the direction substantially opposite the forward drive direction of the vehicle.

Aspects of the subject technology may provide benefits relative to existing systems. For example, aspects of the subject technology may increase or maximize airflow (e.g., provide flows significantly more than existing systems), may provide a lower or equivalent drag (e.g., by synergizing with the front fascia and the front wheel wells, providing lower drag than existing systems), may reduce or minimize frunk and/or underhood heating (e.g., by providing an outlet airflow that is pointed away from the frunk and/or underhood portions of the vehicle), may be provided with or without active grille shutters and/or with “barn door” type active grille shutters, and may reduce or eliminate the need for a grille for heater intrusion protection (e.g., due to the lack of a direct line of sight to heat exchangers when the reverse flow described herein is implemented). For example, the front fascia 132 may shield the fan 310 from the direct outside airflow 300. In one or more implementations, the reverse-flow layout herein described (e.g., in connection with FIGS. 3-9) can achieve the same or more condenser flow (e.g., an increase of five to fifteen percent) as a direct flow layout, with significantly more (e.g., double, triple, four times more, or more than four times more) radiator flow, for the same or less cooling drag. This increased radiator flow may facilitate a reduction in size of the radiator in some implementations, which can provide additional benefits in terms of vehicle weight and efficiency. In one or more implementations, the heat exchanger stack may be lowered and rotated (e.g., and/or the fan 310 may be flipped to be in a pull or push orientation) relative to existing systems, which may provide additional space to increase the size of a front cargo space or other component or space of the vehicle.

Vehicle fascia are often decorative structures that are used to provide an aesthetic outer look to a portion of a vehicle, and often include unused interior spaces or cavities. In accordance with aspects of the disclosure, otherwise unused space within a vehicle fascia can be functionalized as an airflow duct for a thermal management system (e.g., a reverse-flow CRFM system) of the vehicle.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

1. A structural component for a movable apparatus, the structural component comprising:
an outer wall having an interior surface; and
an external surface of the outer wall, the external surface configured to receive a first portion of an airflow in a first direction as a result of motion of the movable apparatus, and
wherein the interior surface is configured to receive a second portion of the airflow in a second direction substantially opposite the first direction.

2. The structural component of claim 1, wherein the movable apparatus comprises a vehicle, wherein the structural component comprises a fascia of the vehicle, wherein the structural component further comprises an internal cavity defined at least in part by the interior surface, and wherein the interior surface is configured to redirect at least some of the second portion of the airflow through the internal cavity to an exit port of the structural component.

3. The structural component of claim 2, wherein the exit port is configured to fluidly couple to a vent in a wheel well of the vehicle, and wherein the fascia forms a part of a thermal management system for the vehicle.

4. The structural component of claim 1, wherein the second portion of the airflow in the second direction that is received by the interior surface is configured to mitigate a drag effect of the airflow on the movable apparatus.

5. An apparatus, comprising:
a body;
an air intake at a front end of the body, the air intake configured to receive airflow in a first direction, due to a motion of the apparatus; and
at least one element configured to redirect at least a portion of the airflow, received due to the motion of the apparatus, in a second direction substantially opposite the first direction to a backside of the front end of the body.

6. The apparatus of claim 5, wherein the at least one element comprises a structural element configured to modify at least the portion of the airflow when the apparatus is in motion.

7. The apparatus of claim 6, wherein the structural element comprises a wall of a front cargo compartment.

8. The apparatus of claim 5, wherein the at least one element comprises a fan configured to move air when the apparatus is stationary.

9. The apparatus of claim 5, wherein the redirected at least the portion of the airflow flows over a heat exchanger into a cavity within the front end.

10. The apparatus of claim 9, wherein an external surface of a wall of the front end is configured to be impacted by another portion of the airflow when the apparatus is in motion, and wherein the backside of the front end comprises an internal surface of the wall of the front end that is configured to be impacted by at least the portion of the airflow while the other portion of the airflow impacts the external surface.

11. The apparatus of claim 10, wherein at least the portion of the airflow that impacts the internal surface of the wall of the front end mitigates a drag effect, on the apparatus, of the redirection of the airflow.

12. The apparatus of claim 9, wherein the cavity of the front end extends from a first portion disposed at a front end of the body of the apparatus to a wall of a wheel well of the body of the apparatus.

13. The apparatus of claim 12, further comprising a vent in the wall of the wheel well, wherein the cavity of the front end is configured to route the airflow to, and through, the vent in the wheel well of the body of the apparatus.

14. The apparatus of claim 10, further comprising at least one opening in a bottom wall of the front end that allows the airflow to flow from the cavity within the front end through the at least one opening to an external environment of the apparatus.

15. The apparatus of claim 14, further comprising at least one flap for the at least one opening in the bottom wall of the front end.

16. The apparatus of claim 5, wherein the front end comprises a bottom fascia disposed below the air intake or a top fascia disposed above the air intake.

17. The apparatus of claim 5, wherein the apparatus is a vehicle, wherein the first direction is substantially opposite to a forward drive direction of the vehicle, and wherein the second direction is substantially parallel with the forward drive direction of the vehicle.

18. An apparatus, comprising:
an air intake configured to receive an airflow in a first direction due to a motion of the apparatus;
a front end having:
an internal cavity fluidly coupled to the air intake, and
at least one element configured to redirect at least a portion of the airflow, received due to the motion of the apparatus, to a second direction substantially opposite the first direction; and
a wheel well having a vent fluidly coupled to the internal cavity.

19. The apparatus of claim 18, further comprising a thermal management system comprising the at least one element, the thermal management system configured to direct airflow from the air intake, through at least a portion of the internal cavity of the front end, and through the vent into the wheel well.

20. The apparatus of claim 18, wherein the apparatus comprises a vehicle, the vehicle further comprising:
a skid plate at or near a bottom of the front end;
a plurality of openings in the skid plate; and
a plurality of flaps for the plurality of openings, the plurality of flaps having an open position that allows air to flow through the plurality of openings, and a closed position that prevents the air from flowing through the plurality of openings.
